(19) United States
(12) Patent Application Publication
(10) Pub. No.: US 2026/0035279 A1
(43) Pub. Date: Feb. 5, 2026

(54) METHODS AND APPARATUS FOR MANUFACTURING A GLASS RIBBON

(71) Applicant: CORNING INCORPORATED, CORNING, NY (US)

(72) Inventors: Minkyun Kim, Yongin-si (KR); Ukhan Kim, Asan (KR); Vinay A Patel, Lexington, KY (US)

(21) Appl. No.: 19/103,334

(22) PCT Filed: Aug. 24, 2023
(86) PCT No.: PCT/US2023/031005

§ 371 Date: Feb. 12, 2025

Related U.S. Application Data
(60) Provisional application No. 63/374,111, filed on Aug. 31, 2022.

(51) Int. Cl. C03B 17/06

(52) U.S. Cl. CPC C03B 17/067; C03B 17/064

(57) ABSTRACT

A glass manufacturing apparatus includes a glass ribbon forming device positioned in a first chamber. The glass manufacturing apparatus includes an enclosure surrounding the first chamber and including a second chamber substantially enclosed and isolated from the first chamber by an enclosure wall of the enclosure. The enclosure wall separates the first chamber from the second chamber. The glass manufacturing apparatus includes a gas supply apparatus in fluid communication with the second chamber. The gas supply apparatus delivers gas to the second chamber such that a first pressure in the first chamber is less than a second pressure in the second chamber.

### CROSS-REFERENCE TO RELATED APPLICATIONS

This application claims the benefit of priority under 35 U.S.C. § 119 of U.S. Provisional Application Ser. No. 63/374,111 filed on Aug. 31, 2022, the content of which is relied upon and incorporated herein by reference in its entirety.

### FIELD

The present disclosure relates generally to apparatus and methods for manufacturing a glass ribbon and, more particularly, to methods for manufacturing a glass ribbon with an enclosure surrounding a glass ribbon forming device.

### BACKGROUND

It is known to manufacture a glass ribbon with a forming device. Conventional forming devices are known to operate to down draw a quantity of molten material from the glass ribbon forming device as the glass ribbon. Particulate material can be present in the air surrounding the glass ribbon, and the particulate material may move upwardly toward the forming device. The particulate material can cause damage to the glass by contacting the glass ribbon.

### SUMMARY

The following presents a simplified summary of the disclosure to provide a basic understanding of some aspects described in the detailed description.

There are set forth methods of manufacturing glass with an enclosure. The enclosure can surround a glass ribbon forming device. The glass ribbon forming device is positioned in a first chamber and the enclosure comprises a second chamber. A gas supply apparatus can be in fluid communication with the enclosure to deliver gas to the second chamber such that a second pressure in the second chamber is greater than a first pressure in the first chamber. Accordingly, gas flow from the first chamber to the second chamber is limited, thus reducing the likelihood of unwanted material or particles traveling upwardly toward the glass ribbon forming device and the first chamber. As used herein, the term “gas” can comprise one or more of air, nitrogen, or a mixture of different gases.

In aspects, a glass manufacturing apparatus can comprise a glass ribbon forming device positioned in a first chamber. The glass manufacturing apparatus can comprise an enclosure surrounding the first chamber and comprising a second chamber enclosed and isolated from the first chamber by an enclosure wall of the enclosure. The enclosure wall can separate the first chamber from the second chamber. The glass manufacturing apparatus can comprise a gas supply apparatus in fluid communication with the second chamber. The gas supply apparatus can deliver gas to the second chamber such that a first pressure in the first chamber can be less than a second pressure in the second chamber. A vertical plane can bisect the glass ribbon forming device, and an axis perpendicular to the vertical plane can intersect the glass ribbon forming device and the second chamber. A second axis parallel to the vertical plane can intersect the glass ribbon forming device and the second chamber.

In aspects, a heating element can be positioned within the second chamber.

In aspects, a ceramic tube can extend through the enclosure and can be in fluid communication with the gas supply apparatus.

In aspects, the enclosure can comprise a plurality of openings in fluid communication with the gas supply apparatus such that the gas supply apparatus can deliver the gas to the second chamber through the plurality of openings.

In aspects, a glass manufacturing apparatus can comprise a glass ribbon forming device positioned in a first chamber. The glass manufacturing apparatus can comprise an enclosure surrounding the first chamber and comprising a first enclosure wall, and a second enclosure wall spaced apart from the first enclosure wall to form a second chamber between the first enclosure wall and the second enclosure wall. The second chamber can be enclosed and isolated from the first chamber. The second enclosure wall can comprise an opening. A gas supply apparatus can be in fluid communication with the opening. The gas supply apparatus can deliver gas through the opening to the second chamber such that a first pressure in the first chamber is less than a second pressure in the second chamber.

In aspects, a third enclosure wall can be attached to the first enclosure wall and the second enclosure wall.

In aspects, the third enclosure wall can extend perpendicular to the first enclosure wall and the second enclosure wall.

In aspects, the third enclosure wall can comprise a second opening in fluid communication with the gas supply apparatus such that the gas supply apparatus can deliver gas through the second opening to the second chamber.

In aspects, a heating element can be positioned within the second chamber.

In aspects, a vertical plane can bisect the glass ribbon forming device, and an axis perpendicular to the vertical plane can intersect the glass ribbon forming device and the second chamber.

In aspects, a second axis can be parallel to the vertical plane and can intersect the glass ribbon forming device and the second chamber.

In aspects, a ceramic tube can extend through the opening and in fluid communication with the gas supply apparatus.

In aspects, methods of manufacturing a ribbon can comprise directing a glass ribbon from a glass ribbon forming device along a travel path in a travel direction. The glass ribbon forming device can be positioned in a first chamber. Methods can comprise delivering gas to a second chamber to increase a second pressure in the second chamber such that the second pressure is greater than a first pressure in the first chamber. The first chamber can be enclosed within the second chamber comprising an enclosure surrounding the first chamber.

In aspects, the gas can be delivered to the second chamber through a plurality of openings in the enclosure.

In aspects, methods can comprise heating the first chamber with a heating element positioned within the second chamber.

In aspects, delivering the gas can comprise directing the gas away from the heating element.

In aspects, methods can comprise positioning the enclosure such that a vertical plane can bisect the glass ribbon forming device, and an axis perpendicular to the vertical plane can intersect the glass ribbon forming device and the second chamber.

In aspects, a second axis parallel to the vertical plane can intersect the glass ribbon forming device and the second chamber.

Additional features and advantages of the aspects disclosed herein will be set forth in the detailed description that follows, and in part will be clear to those skilled in the art from that description or recognized by practicing the aspects described herein, including the detailed description which follows, the claims, as well as the appended drawings. It is to be understood that both the foregoing general description and the following detailed description present aspects intended to provide an overview or framework for understanding the nature and character of the aspects disclosed herein. The accompanying drawings are included to provide further understanding and are incorporated into and constitute a part of this specification. The drawings illustrate various aspects of the disclosure, and together with the description explain the principles and operations thereof.

### BRIEF DESCRIPTION OF THE DRAWINGS

These and other features, aspects and advantages are better understood when the following detailed description is read with reference to the accompanying drawings, in which:

FIG. 1 schematically illustrates example aspects of a glass manufacturing apparatus in accordance with aspects of the disclosure:

FIG. 2 illustrates a perspective cross-sectional view of the glass manufacturing apparatus along lines 2-2 of FIG. 1 in accordance with aspects of the disclosure:

FIG. 3 illustrates a side view of the glass manufacturing apparatus along lines 3-3 of FIG. 2 in accordance with aspects of the disclosure;

FIG. 4 illustrates a perspective view of an enclosure of the glass manufacturing apparatus in accordance with aspects of the disclosure:

FIG. 5 illustrates a top-down view of the enclosure along lines 5-5 of FIG. 4 in accordance with aspects of the disclosure; and

FIG. 6 illustrates a side view of the glass manufacturing apparatus similar to FIG. 3 with a tube in accordance with aspects of the disclosure.

### DETAILED DESCRIPTION

Aspects will now be described more fully hereinafter with reference to the accompanying drawings in which example aspects are shown. Whenever possible, the same reference numerals are used throughout the drawings to refer to the same or like parts. However, this disclosure may be embodied in many different forms and should not be construed as limited to the aspects set forth herein.

As used herein, the term “about” means that amounts, sizes, formulations, parameters, and other quantities and characteristics are not, and need not be, exact, but may be approximate and/or larger or smaller, as desired, reflecting tolerances, conversion factors, rounding off, measurement error and the like, and other factors known to those of skill in the art.

Ranges can be expressed herein as from “about” one value, and/or to “about” another value. When such a range is expressed, aspects include from the one value to the other value. Similarly, when values are expressed as approximations by use of the antecedent “about,” it will be understood that the value forms another aspect. It will be further understood that the endpoints of each of the ranges are significant both in relation to the other endpoint, and independently of the other endpoint.

Directional terms as used herein—for example up, down, right, left, front, back, top, bottom, upper, lower, etc.—are made only with reference to the figures as drawn and are not intended to imply absolute orientation.

Unless otherwise expressly stated, it is in no way intended that any methods set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred in any respect. This holds for any possible non-express basis for interpretation, including matters of logic relative to arrangement of steps, operational flow, order of components, or orientation of components: plain meaning derived from grammatical organization or punctuation, and: the number or type of aspects described in the specification.

As used herein, the singular forms “a,” “an” and “the” include plural references unless the context clearly dictates otherwise. Thus, for example, reference to “a” component includes aspects having two or more such components, unless the context clearly indicates otherwise.

The word “exemplary,” “example,” or various forms thereof are used herein to mean serving as an example, instance, or illustration. Any aspect or design described herein as “exemplary” or as an “example” should not be construed as preferred or advantageous over other aspects or designs. Furthermore, examples are provided solely for purposes of clarity and understanding and are not meant to limit or restrict the disclosed subject matter or relevant portions of this disclosure in any manner. It can be appreciated that a myriad of additional or alternate examples of varying scope could have been presented but have been omitted for purposes of brevity.

As used herein, the terms “comprising” and “including”, and variations thereof, shall be construed as synonymous and open-ended, unless otherwise indicated. A list of elements following the transitional phrases comprising or including is a non-exclusive list, such that elements in addition to those specifically recited in the list may also be present.

The terms “substantial,” “substantially,” and variations thereof as used herein are intended to represent that a described feature is equal or approximately equal to a value or description. For example, a “substantially planar” surface is intended to denote a surface that is planar or approximately planar. Moreover, “substantially” is intended to denote that two values are equal or approximately equal. The term “substantially” may denote values within about 10% of each other, for example, within about 5% of each other, or within about 2% of each other.

Modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first end and a second end generally correspond to end A and end B or two different ends.

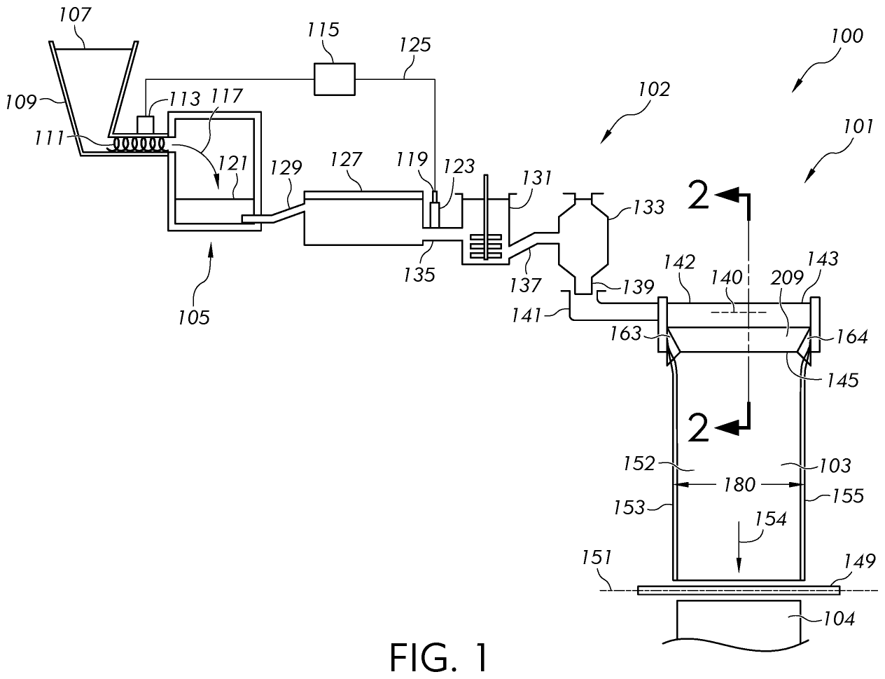

The present disclosure relates to a glass manufacturing apparatus and methods for producing a glass ribbon. Methods and apparatus for producing a glass ribbon from a glass material will now be described by way of example aspects. As schematically illustrated in FIG. 1, in aspects, an exemplary glass manufacturing apparatus 100 can comprise a glass melting and delivery apparatus 102 and a glass ribbon forming device 101 designed to produce a glass ribbon 103 from a quantity of molten material 121. The glass ribbon 103 can comprise a central portion 152 positioned between opposite edge portions (e.g., edge beads) formed along a first outer edge 153 and a second outer edge 155 of the glass ribbon 103, wherein a thickness of the edge portions can be greater than a thickness of the central portion. Additionally, in aspects, a separated glass ribbon 104 can be separated from the glass ribbon 103 along a separation path 151 by a glass separator 149 (e.g., scribe, score wheel, diamond tip, laser, etc.).

In aspects, the glass melting and delivery apparatus 102 can comprise a melting vessel 105 oriented to receive batch material 107 from a storage bin 109. The batch material 107 can be introduced by a batch delivery device 111 powered by a motor 113. In aspects, an optional controller 115 can be operated to activate the motor 113 to introduce a desired amount of batch material 107 into the melting vessel 105, as indicated by arrow 117. The melting vessel 105 can heat the batch material 107 to provide molten material 121. In aspects, a melt probe 119 can be employed to measure a level of molten material 121 within a standpipe 123 and communicate the measured information to the controller 115 by way of a communication line 125.

Additionally, in aspects, the glass melting and delivery apparatus 102 can comprise a first conditioning station comprising a fining vessel 127 located downstream from the melting vessel 105 and coupled to the melting vessel 105 by way of a first connecting conduit 129. In aspects, molten material 121 can be gravity fed from the melting vessel 105 to the fining vessel 127 by way of the first connecting conduit 129. For example, in aspects, gravity can drive the molten material 121 through an interior pathway of the first connecting conduit 129 from the melting vessel 105 to the fining vessel 127. Additionally, in aspects, bubbles can be removed from the molten material 121 within the fining vessel 127 by various techniques.

In aspects, the glass melting and delivery apparatus 102 can further comprise a second conditioning station comprising a mixing chamber 131 that can be located downstream from the fining vessel 127. The mixing chamber 131 can be employed to provide a homogenous composition of molten material 121, thereby reducing or eliminating inhomogeneity that may otherwise exist within the molten material 121 exiting the fining vessel 127. As shown, the fining vessel 127 can be coupled to the mixing chamber 131 by way of a second connecting conduit 135. In aspects, molten material 121 can be gravity fed from the fining vessel 127 to the mixing chamber 131 by way of the second connecting conduit 135. For example, in aspects, gravity can drive the molten material 121 through an interior pathway of the second connecting conduit 135 from the fining vessel 127 to the mixing chamber 131.

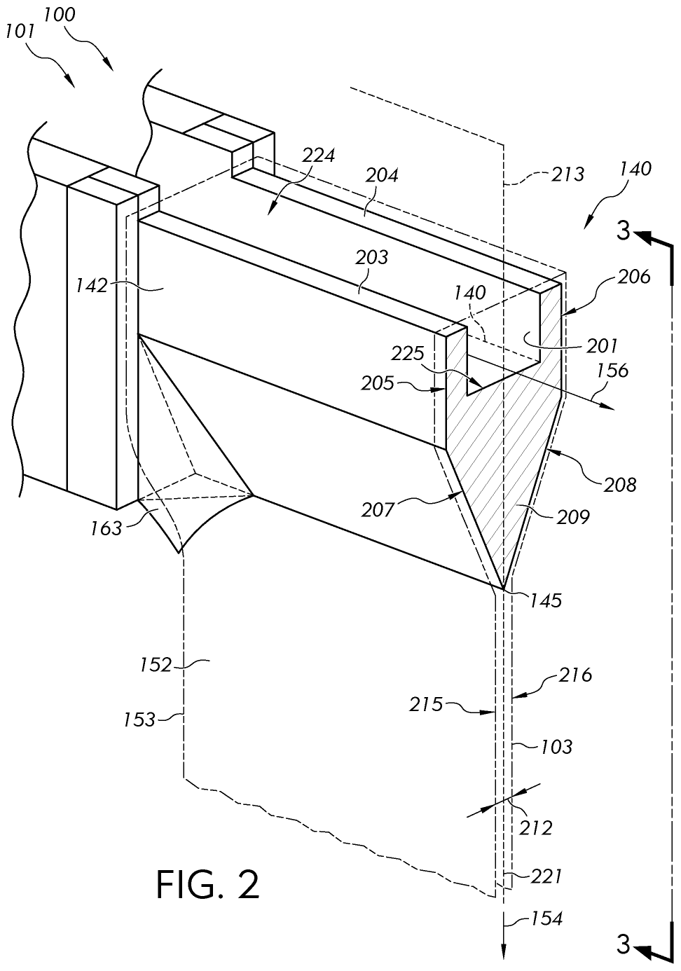

Additionally, in aspects, the glass melting and delivery apparatus 102 can comprise a third conditioning station comprising a delivery chamber 133 that can be located downstream from the mixing chamber 131. In aspects, the delivery chamber 133 can condition the molten material 121 to be fed into an inlet conduit 141. For example, the delivery chamber 133 can function as an accumulator and/or flow controller to adjust and provide a consistent flow of molten material 121 to the inlet conduit 141. As shown, the mixing chamber 131 can be coupled to the delivery chamber 133 by way of a third connecting conduit 137. In aspects, molten material 121 can be gravity fed from the mixing chamber 131 to the delivery chamber 133 by way of the third connecting conduit 137. For example, in aspects, gravity can drive the molten material 121 through an interior pathway of the third connecting conduit 137 from the mixing chamber 131 to the delivery chamber 133. As further illustrated, in aspects, a delivery pipe 139 can be positioned to deliver molten material 121 to forming device 101, for example the inlet conduit 141 of the glass ribbon forming device 101. The glass ribbon forming device 101 can comprise a trough (e.g., trough 201 illustrated in FIG. 2) extending along a trough axis 140 between an inlet end 142 and an opposing end 143 of the glass ribbon forming device 101 opposite the inlet end 142. The inlet end 142 is the end of the trough 201 in proximity to the inlet conduit 141 through which the molten material 121 is received. The opposing end 143 is the end farthest from the inlet conduit 141.

By way of illustration, the glass ribbon forming device 101 shown and disclosed below can be provided to fusion draw molten material 121 off a bottom edge, defined as a root 145, of a forming wedge 209 to produce the glass ribbon 103. For example, in aspects, the molten material 121 can be delivered from the inlet conduit 141 to the glass ribbon forming device 101. The molten material 121 can then be formed into the glass ribbon 103 based, in part, on the structure of the glass ribbon forming device 101. For example, as shown, the molten material 121 can be drawn off the bottom edge (e.g., root 145) of the glass ribbon forming device 101 along a draw path extending in a travel direction 154 of the glass manufacturing apparatus 100. In aspects, edge directors 163, 164 can direct the molten material 121 off the glass ribbon forming device 101 and define, in part, a width 108 of the glass ribbon 103. In aspects, the width 108 of the glass ribbon 103 extends between the first outer edge 153 of the glass ribbon 103 and the second outer edge 155 of the glass ribbon 103.

In aspects, the width 108 of the glass ribbon 103, which extends between the first outer edge 153 of the glass ribbon 103 and the second outer edge 155 of the glass ribbon 103, can be greater than or equal to about 20 millimeters (mm), for example, greater than or equal to about 50 mm, for example, greater than or equal to about 100 mm, for example, greater than or equal to about 500 mm, for example, greater than or equal to about 1000 mm, for example, greater than or equal to about 2000 mm, for example, greater than or equal to about 3000 mm, for example, greater than or equal to about 4000 mm, although other widths less than or greater than the widths mentioned above can be provided in aspects. For example, in aspects, the width 108 can be within a range from about 20 mm to about 4000 mm, for example, within a range from about 50 mm to about 4000 mm, for example, within a range from about 100 mm to about 4000 mm, for example, within a range from about 500 mm to about 4000 mm, for example, within a range from about 1000 mm to about 4000 mm, for example, within a range from about 2000 mm to about 4000 mm, for example, within a range from about 3000 mm to about 4000 mm, for example, within a range from about 20 mm to about 3000 mm, for example, within a range from about 50 mm to about 3000 mm, for example, within a range from about 100 mm to about 3000 mm, for example, within a range from about 500 mm to about 3000 mm, for example, within a range from about 1000 mm to about 3000 mm, for example, within a range from about 2000 mm to about 3000 mm, for example, within a range from about 2000 mm to about 2500 mm, and all ranges and subranges therebetween.

FIG. 2 shows a cross-sectional perspective view of the glass ribbon forming device 101 along line 2-2 of FIG. 1. In aspects, the glass ribbon forming device 101 can comprise a trough 201 oriented to receive the molten material 121 from the inlet conduit 141. For illustrative purposes, cross-hatching of the molten material 121 is removed from FIG. 2 for clarity. The glass ribbon forming device 101 comprises a pair of weirs 203, 204 defining an opening 224 in the trough 201. The glass ribbon forming device 101 comprises a bottom surface 225, which may be substantially planar, and may extend at least partially between the inlet end 142 and the opposing end 143 (e.g., illustrated in FIG. 1). The bottom surface 225 can at least partially define the trough 201, for example, with the bottom surface 225 extending along a bottom of the trough 201 and the pair of weirs 203, 204 extending along opposing sides of the trough 201. The glass ribbon forming device 101 can further comprise the forming wedge 209 comprising a pair of downwardly inclined converging surface portions 207, 208 extending between opposed ends of the forming wedge 209. The pair of downwardly inclined converging surface portions 207, 208 of the forming wedge 209 can converge along the travel direction 154 to intersect along the root 145 (e.g., a bottom edge of the forming wedge 209 where the converging surface portions 207, 208 meet) of the glass ribbon forming device 101. A draw plane 213 of the glass manufacturing apparatus 100 can extend through the root 145 along the travel direction 154. In aspects, the glass ribbon 103 can be drawn in the travel direction 154 along the draw plane 213. As shown, the draw plane 213 can bisect the forming wedge 209 through the root 145 although, in aspects, the draw plane 213 can extend at other orientations relative to the root 145. In aspects, the glass ribbon 103 can move along a travel path 221 that may be co-planar with the draw plane 213 in the travel direction 154.

Additionally, the molten material 121 can flow in a flow direction 156 into and along the trough 201 of the glass ribbon forming device 101. The molten material 121 can then overflow from the trough 201 by flowing over corresponding weirs 203, 204, through the opening 224, and downwardly over the outer surfaces 205, 206 of the corresponding weirs 203, 204. Respective streams of molten material 121 can then flow along the downwardly inclined converging surface portions 207, 208 of the forming wedge 209 and be drawn off the root 145 of the glass ribbon forming device 101, where the flows converge and fuse into the glass ribbon 103. The glass ribbon 103 can then be drawn along the travel direction 154. In aspects, the glass ribbon 103 comprises one or more states of material based on a vertical location of the glass ribbon 103, i.e., distance from the root 145. For example, at a first location, the glass ribbon 103 can comprise the viscous molten material 121, and at a second location, the glass ribbon 103 can comprise an amorphous solid in a glassy state (e.g., a glass ribbon).

The glass ribbon 103 comprises a first major surface 215 and a second major surface 216 facing opposite directions and defining a thickness 212 (e.g., average thickness) of the glass ribbon 103 therebetween. In aspects, the thickness 212 of the glass ribbon 103 can be less than or equal to about 2 millimeters (mm), less than or equal to about 1 millimeter, less than or equal to about 0.5 millimeters, for example, less than or equal to about 300 micrometers (μm), less than or equal to about 200 micrometers, or less than or equal to about 100 micrometers, although other thicknesses may be provided in further aspects. For example, in aspects, the thickness 212 of the glass ribbon 103 can be within a range from about 20 micrometers to about 200 micrometers, within a range from about 50 micrometers to about 750 micrometers, within a range from about 100 micrometers to about 700 micrometers, within a range from about 200 micrometers to about 600 micrometers, within a range from about 300 micrometers to about 500 micrometers, within a range from about 50 micrometers to about 500 micrometers, within a range from about 50 micrometers to about 700 micrometers, within a range from about 50 micrometers to about 600 micrometers, within a range from about 50 micrometers to about 500 micrometers, within a range from about 50 micrometers to about 400 micrometers, within a range from about 50 micrometers to about 300 micrometers, within a range from about 50 micrometers to about 200 micrometers, within a range from about 50 micrometers to about 100 micrometers, within a range from about 25 micrometers to about 125 micrometers, comprising all ranges and subranges of thicknesses therebetween. In addition, the glass ribbon 103 can comprise a variety of compositions, for example, one or more of soda-lime glass, borosilicate glass, alumino-borosilicate glass, alkali-containing glass, alkali-free glass, aluminosilicate, borosilicate, boroaluminosilicate, silicate, glass-ceramic, or other materials comprising glass. In aspects, the glass ribbon 103 can comprise one or more of lithium fluoride (LiF), magnesium fluoride (MgF₂), calcium fluoride (CaF₂), barium fluoride (BaF₂), sapphire (Al₂O₃), zinc selenide (ZnSe), germanium (Ge) or other materials.

In aspects, the glass separator 149 (see FIG. 1) can separate the glass ribbon 104 from the glass ribbon 103 along the separation path 151 to provide a plurality of separated glass ribbons 104 (i.e., a plurality of sheets of glass). In aspects, a longer portion of the separated glass ribbon 104 may be coiled onto a storage roll. The separated glass ribbon can then be processed into a desired application, e.g., a display application. For example, the separated glass ribbon can be used in a wide range of display and non-display applications comprising, but not limited to, liquid crystal displays (LCDs), electrophoretic displays (EPD), organic light emitting diode displays (OLEDs), plasma display panels (PDPs), microLED displays, miniLED displays, organic light emitting diode lighting, light emitting diode lighting, augmented reality (AR), virtual reality (VR), touch sensors, photovoltaics, foldable phones, or other applications.

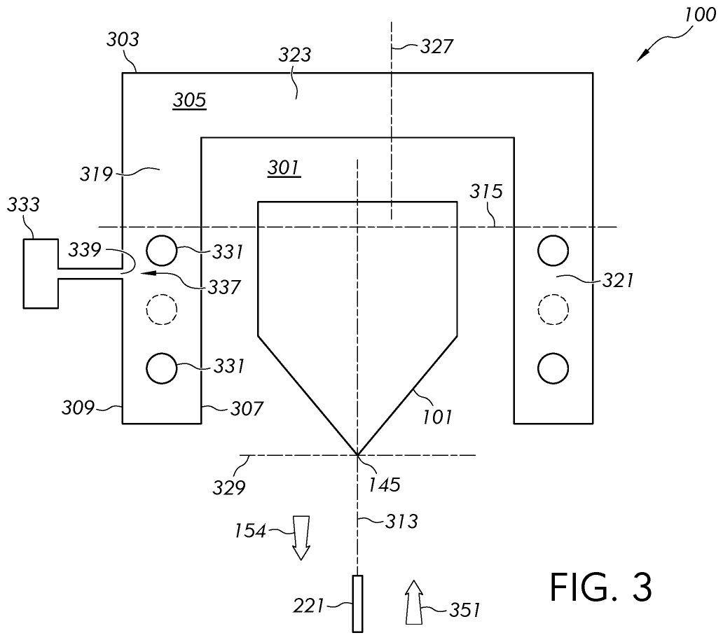

FIG. 3 illustrates a side view of the glass manufacturing apparatus 100 along lines 3-3 of FIG. 2. The glass ribbon forming device 101 can define the travel path 221 along which the glass ribbon 103 travels in the travel direction 154. In aspects, methods of manufacturing the glass ribbon 103 can comprise directing the glass ribbon 103 from the glass ribbon forming device 101 along the travel path 221 in the travel direction 154, for example, with the glass ribbon 103 moving in the direction of gravity. The glass ribbon forming device 101 is positioned in a first chamber 301.

The glass manufacturing apparatus 100 comprises an enclosure 303 surrounding the first chamber 301. The enclosure 303 can comprise a plurality of walls that surround the first chamber 301 and the glass ribbon forming device 101. In aspects, surrounding the first chamber 301 and the glass ribbon forming device 101 can extend along a plurality of sides (e.g., all sides, for example) of the glass ribbon forming device 101 and above the glass ribbon forming device 101 relative to the direction of gravity. In this way, the first chamber 301 and the glass ribbon forming device 101 can be located, e.g., housed, within the enclosure 303.

The plurality of walls of the enclosure 303 can form a second chamber 305. For example, the enclosure 303 can comprise the second chamber 305, with the second chamber 305 substantially enclosed and isolated from the first chamber by an enclosure wall of the enclosure 303. In aspects, the enclosure 303 can comprise a first enclosure wall 307, a second enclosure wall 309, etc. The first enclosure wall 307 can separate the first chamber 301 from the second chamber 305. In aspects, the second enclosure wall 309 can be spaced apart form the first enclosure wall 307 to form the second chamber 305 between the first enclosure wall 307 and the second enclosure wall 309. The enclosure walls 307, 309 can comprise a material that is resistant to deformation due to the temperature within the first chamber 301. In aspects, the enclosure walls 307, 309 can comprise one or more of a refractory material, a metal material, etc. By being enclosed and isolated from the first chamber 301, the second chamber 305 may be bounded on all sides by enclosure walls 307, 309 of the enclosure 303. Further, the second chamber 305 may not be in fluid communication with the first chamber 301 due to the presence of the enclosure walls 307, 309 that bound the second chamber 305. In aspects, the first enclosure wall 307 may comprise one or more openings that can facilitate the glass manufacturing process. These one or more openings may be filled, for example, with thermocouples or other temperature sensing devices. In aspects, a seal may not be formed between the thermocouples and the first enclosure wall 307, such that air or gas can pass through the first enclosure wall 307 between the first chamber 301 and the second chamber 305.

In aspects, the enclosure 303 surrounds the first chamber 301 such that the second chamber 305 is positioned on multiple sides of the glass ribbon forming device 101. For example, a vertical plane 313 can bisect the glass ribbon forming device 101. By bisecting the glass ribbon forming device 101, the vertical plane 313 can extend through the glass ribbon forming device 101 along the root 145 and through the inlet end 142 and the opposing end 143 (e.g., ends 142, 143 illustrated in FIG. 1), such that the vertical plane 313 divides the glass ribbon forming device 101 into two substantially equal parts. The vertical plane 313 can extend parallel to the travel direction 154 and may be parallel to and/or lying within the draw plane 213 (e.g., illustrated in FIG. 2), and parallel to the glass ribbon 103.

In aspects, an axis 315 can be substantially perpendicular to the vertical plane 313, with the axis 315 intersecting the glass ribbon forming device 101 and the second chamber 305. For example, the second chamber 305 can comprise a plurality of chamber portions, such as a first chamber portion 319, a second chamber portion 321, and a third chamber portion 323. The first chamber portion 319 can be located on a first side of the glass ribbon forming device 101 and the second chamber portion 321 can be located on an opposing second side of the glass ribbon forming device 101. The third chamber portion 323 can be located above the glass ribbon forming device 101 and can connect the first chamber portion 319 to the second chamber portion 321 such that the first chamber portion 319 and the second chamber portion 321 are in fluid communication through the third chamber portion 323. The axis 315 can intersect the first chamber portion 319 and the second chamber portion 321 while not intersecting the third chamber portion 323. For example, the axis 315 can intersect the enclosure walls 307, 309, but may be spaced a distance apart from the third chamber portion 323.

In aspects, a second axis 327 can extend substantially parallel to the vertical plane 313 and may intersect the glass ribbon forming device 101 and the second chamber 305. For example, the second axis 327 can lie within the vertical plane 313 or may be parallel to but not lying within the vertical plane 313. The second axis 327 can intersect the glass ribbon forming device 101 and the third chamber portion 323, while not intersecting the first chamber portion 319 and the second chamber portion 321. In this way, the second axis 327 may not intersect the enclosure walls 307, 309, but, rather, may intersect other enclosure walls of the enclosure 303 (e.g., walls that form an upper and lower boundary of the third chamber portion 323). In this way, the glass ribbon forming device 101 can be substantially surrounded by the enclosure 303 and the second chamber 305. Accordingly, methods can comprise positioning the enclosure such that the vertical plane 313 bisects the glass ribbon forming device 101, and the axis 315 substantially perpendicular to the vertical plane 313 intersects the glass ribbon forming device 101 and the second chamber 305.

In aspects, the second chamber 305 can be positioned partially or completely above the root 145 relative to the vertical plane 313. For example, a root axis 329 can intersect the root 145, with the root axis 329 extending substantially perpendicularly to the vertical plane 313. In aspects, and as illustrated in FIG. 3, the root axis 329 may be positioned below the enclosure 303 and, as such, below the second chamber 305. In this way, in aspects, the second chamber 305 may be located completely above the root 145 and the root axis 329. However, the enclosure 303 is not so limited, and, in aspects, the enclosure 303 can extend downwardly such that the root axis 329 can intersect the second chamber 305. In this way, a portion of the second chamber 305 may be positioned above the root axis 329 and a remaining portion of the second chamber 305 may be positioned below the root axis 329.

In aspects, the glass manufacturing apparatus 100 can comprise one or more heating elements 331 positioned within the second chamber 305. The heating elements 331 can comprise, for example, resistance heating elements that can convert electrical energy into heat through Joule heating, with electric current passing through the heating elements 331 and encountering resistance, thus causing heating of the heating elements 331. The heating elements 331 can increase a temperature within the second chamber 305, which can facilitate maintaining a temperature within the first chamber 301 during the glass manufacturing process. In aspects, the heating elements 331 may be spaced apart and located within some or all of the chamber portions 319, 321, 323. For example, a first portion of the heating elements 331 may be located in the first chamber portion 319 (e.g., two heating elements in FIG. 3), a second portion of the heating elements 331 (e.g., two heating elements in FIG. 3) may be located in the second chamber portion 321, and zero heating elements may be positioned in the third chamber portion 323. In aspects, the heating elements 331 can be positioned in the first chamber portion 319 and the second chamber portion 321 such that the axis 315 can intersect one or more of the heating elements 331 in the first chamber portion 319 and/or one or more of the heating elements 331 in the second chamber portion 321. Accordingly, methods can comprise heating the first chamber 301 with a heating element 331 positioned within the second chamber 305.

In aspects, the glass manufacturing apparatus 100 can comprise a gas supply apparatus 333 in fluid communication with the second chamber 305. The gas supply apparatus 333 can deliver gas to the second chamber 305 such that a first pressure in the first chamber 301 is less than a second pressure in the second chamber 305. In aspects, the gas supply apparatus 333 can comprise a gas source, such as, for example, a pump, a cannister, a cartridge, a boiler, a compressor, and/or a pressure vessel. The gas supply apparatus 333 delivers compressed gas, for example, gas kept under a pressure that is greater than atmospheric pressure. The gas supply apparatus 333 is positioned at an exterior of the enclosure 303 to reduce the likelihood of damage to the gas supply apparatus 333. In aspects, the gas supply apparatus 333 is positioned on an opposite side of the enclosure walls 307, 309 from the first chamber 301, with the second enclosure wall 309 positioned between the gas supply apparatus 333 and the second chamber 305.

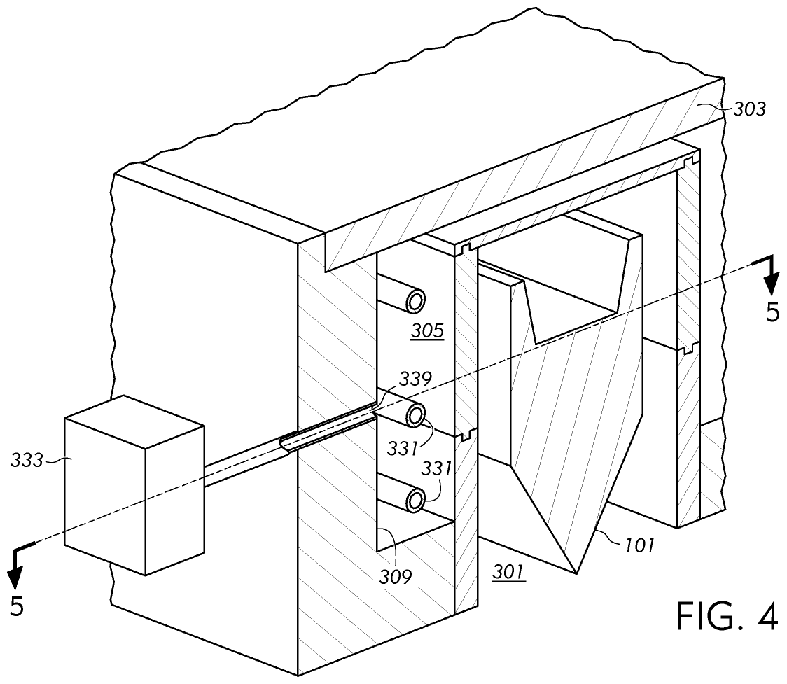

In aspects, the second enclosure wall 309 comprises one or more openings 337 in fluid communication with the gas supply apparatus 333 such that the gas supply apparatus 333 can deliver the gas to the second chamber 305 through the openings 337. For example, the one or more opening 337 can comprise a first opening 339 extending through the second enclosure wall 309. Referring to FIG. 4, the first opening 339 can extend through the second enclosure wall 309 such that the first opening 339 forms a gas flow passage between an exterior of the enclosure 303 and the second chamber 305. The gas supply apparatus 333 can be attached to the first opening 339 via a conduit that extends through and/or is in fluid communication with the first opening 339. As used herein, fluid communication can comprise a gas-flow path between two or more cavities. The gas-flow path between the gas supply apparatus 333 and the second chamber 305 can comprise a sealed volume or cavity, such that the gas supply apparatus 333 can deliver gas through the first opening 339 and into the second chamber 305.

By delivering gas through the first opening 339 to the second chamber 305, a first pressure in the first chamber 301 may be less than a second pressure in the second chamber 305. For example, the gas supply apparatus 333 can continue to deliver gas through the first opening 339 until the second pressure is reached. Accordingly, methods can comprise delivering gas to the second chamber 305 to increase the second pressure in the second chamber 305 such that the second pressure is greater than the first pressure in the first chamber 301, wherein the first chamber 301 is substantially enclosed within the second chamber 305 comprising the enclosure 303 surrounding the first chamber 301.

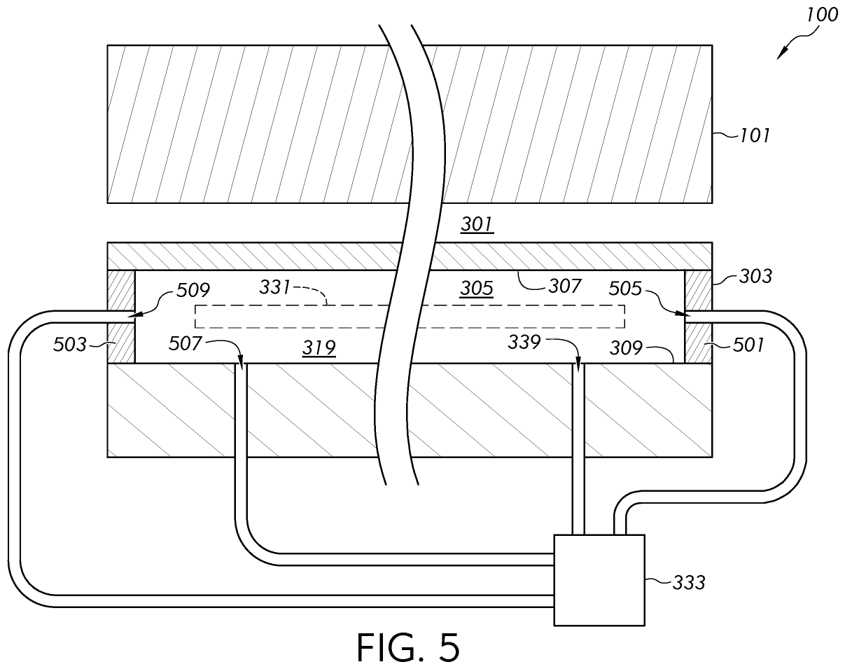

FIG. 5 illustrates a top-down sectional view of the glass manufacturing apparatus 100 along lines 5-5 of FIG. 4. The enclosure 303 can comprise a third enclosure wall 501 and a fourth enclosure wall 503 that attach the first enclosure wall 307 and the second enclosure wall 309. In aspects, the third enclosure wall 501 can be attached to the first enclosure wall 307 and the second enclosure wall 309, for example, at first ends of the first enclosure wall 307 and the second enclosure wall 309, and the fourth enclosure wall 503 can be attached to the first enclosure wall 307 and the second enclosure wall 309, for example, at opposing second ends of the first enclosure wall 307 and the second enclosure wall 309. In aspects, the first enclosure wall 307 and the second enclosure wall 309 can extend substantially parallel to one another, and the third enclosure wall 501 and the fourth enclosure wall 503 can extend substantially parallel to one another, with the first enclosure wall 307 and the second enclosure wall 309 extending substantially perpendicularly to the third enclosure wall 501 and the fourth enclosure wall 503. Together, the enclosure walls 307, 309, 501, 503 can form the boundary of the first chamber portion 319 of the second chamber 305.

In aspects, the openings 337 are not limited to the first opening 339, but can comprise other openings, for example, a second opening 505 in the third enclosure wall 501, a third opening 507 in the fourth enclosure wall 503, a fourth opening 509 in the second enclosure wall 309, etc. The third enclosure wall 501 can comprise the second opening 505, which may be in fluid communication with the gas supply apparatus 333 such that the gas supply apparatus 333 can deliver gas through the second opening 505 to the second chamber 305. In this way, the gas supply apparatus 333 can be in fluid communication with the openings 339, 505, 507, 509 to deliver gas to the second chamber 305 at a plurality of locations. In aspects, the enclosure 303 is not limited to the openings 339, 505, 507, 509 in fluid communication with the first chamber portion 319 of the second chamber 305. Rather, in aspects, additional openings can be located at different walls of the enclosure 303, with these additional openings adjacent to and in fluid communication with the second chamber portion 321 and/or the third chamber portion 323 (e.g., illustrated in FIG. 3).

By positioning the openings 339, 505, 507, 509 at different locations and at different enclosure walls 309, 501, 503 of the enclosure 303, several benefits can be achieved. For example, the gas supply apparatus 333 can deliver gas to a plurality of locations within the first chamber portion 319, which can provide a reduced pressure variation within the first chamber portion 319. For example, the first opening 339 and the third opening 507 may be spaced apart and extend through the second enclosure wall 309. The second opening 505 may be spaced apart from the first opening 339, and the fourth opening 509 may be spaced apart from the third opening 507. As such, the second chamber 305 can reach the second pressure faster (e.g., due to the plurality of openings) with a reduced pressure variation throughout the first chamber portion 319 and, thus, a more constant second pressure. While the enclosure 303 is illustrated in FIG. 5 comprising four openings 339, 505, 507, 509, additional openings may be provided in fluid communication with the gas supply apparatus 333.

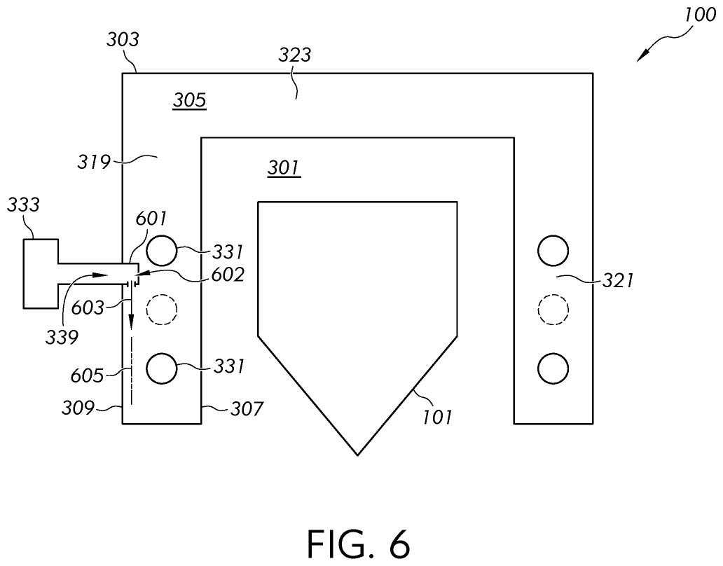

FIG. 6 illustrates a side view of the glass manufacturing apparatus 100 with a tube 601 extending through the opening 339. In aspects, the tube 601 can comprise a ceramic tube that can extend from the second enclosure wall 309 and into the second chamber 305. The tube 601 can comprise a discharge port 602 (e.g., opening) through which gas 603 from the gas supply apparatus 333 can exit the tube 601 and enter the second chamber 305. The gas 603 can exit the discharge port 602 along a gas flow axis 605. In aspects, the gas flow axis 605 can be angled in a direction away from the heating elements 331, such that the gas flow axis 605 may not intersect the heating elements 331. For example, the tube 601 (e.g., ceramic tube) can extend through the opening 339 of the enclosure 303 and may be in fluid communication with the gas supply apparatus 333. The gas 603 can exit the discharge port 602 and flow in a direction of the gas flow axis 605, such that the gas 603 may not intersect or impinge upon the heating elements 331. In this way, when the heating elements 331 are at a temperature higher than the gas 603, the gas 603 may not impinge upon and cool the heating elements 331, thus allowing for a temperature to be maintained within the second chamber 305.

Maintaining the second chamber 305 at the second pressure, which is greater than the first pressure of the first chamber 301, can yield several benefits. For example, referring to FIG. 3, during the glass manufacturing process, gas may travel in a flow direction 351 upwardly along the vertical plane 313 and toward the glass ribbon forming device 101 (e.g., “chimney effect”). In aspects, particles may be present in the atmosphere surrounding the glass ribbon, such that the particles may be drawn upwardly in the flow direction 351 toward the glass ribbon forming device 101. These particles may comprise, for example, glass particles formed during separation processes carried out below the forming body, dust, debris, or other forms of particles that may be found in a manufacturing environment. These particles may contact and adhere to the molten glass, thus reducing glass quality. By increasing the second pressure within the second chamber 305 to be greater than the first pressure of the first chamber 301, pressure loss within the first chamber 301 can be reduced. For example, the first enclosure wall 307 may comprise one or more openings through which thermocouples may be positioned. The openings and the thermocouples may not be sealed, thus providing a gas-flow passage from the first chamber 301 to the second chamber 305. If the first pressure is greater than the second pressure, then pressure loss from the first chamber 301 to the second chamber 305 may occur, which can increase the flow velocity in the flow direction 351 of the particles. However, due to the second pressure being greater than the first pressure, the first chamber 301 may not lose pressure to the second chamber 305, such that the particulate flow in the flow direction 351 can be reduced or stopped.

When the second pressure is greater than the first pressure, then there may be substantially zero pressure loss from the first chamber 301 to the second chamber 305. Likewise, when the second pressure is substantially equal to the first pressure, then there may be substantially zero pressure loss from the first chamber 301 to the second chamber 305. With pressure loss reduced, and with reduced particulate flow in the flow direction 351, the number of particles in the first chamber 301 surrounding the glass ribbon forming device 101 can be reduced, thus reducing the likelihood of a particulate contacting the molten glass. Further, by addressing pressurization at a location above the root 145, the enclosure 303 can simultaneously heat the first chamber 301, for example, with the heating elements 331, while reducing the upward flow toward the first chamber 301.

It should be understood that while various aspects have been described in detail relative to certain illustrative and specific examples thereof, the present disclosure should not be considered limited to such, as numerous modifications and combinations of the disclosed features are possible without departing from the scope of the following claims.

1. A glass manufacturing apparatus comprising:
a glass ribbon forming device positioned in a first chamber;
an enclosure surrounding the first chamber and comprising a second chamber enclosed and isolated from the first chamber by an enclosure wall of the enclosure, the enclosure wall separating the first chamber from the second chamber; and
a gas supply apparatus in fluid communication with the second chamber, the gas supply apparatus configured to deliver gas to the second chamber such that a first pressure in the first chamber is less than a second pressure in the second chamber, wherein a vertical plane bisects the glass ribbon forming device, and an axis perpendicular to the vertical plane intersects the glass ribbon forming device and the second chamber, and wherein a second axis parallel to the vertical plane intersects the glass ribbon forming device and the second chamber.

2. The glass manufacturing apparatus of claim 1, further comprising a heating element positioned within the second chamber.

3. The glass manufacturing apparatus of claim 1, further comprising a ceramic tube extending through the enclosure and in fluid communication with the gas supply apparatus.

4. The glass manufacturing apparatus of claim 1, wherein the enclosure comprises a plurality of openings in fluid communication with the gas supply apparatus such that the gas supply apparatus is configured to deliver the gas to the second chamber through the plurality of openings.

5. A glass manufacturing apparatus comprising:
a glass ribbon forming device positioned in a first chamber;
an enclosure surrounding the first chamber and comprising:
a first enclosure wall; and
a second enclosure wall spaced apart from the first enclosure wall to form a second chamber between the first enclosure wall and the second enclosure wall, the second chamber enclosed and isolated from the first chamber, the second enclosure wall comprising an opening: and
a gas supply apparatus in fluid communication with the opening, the gas supply apparatus configured to deliver gas through the opening to the second chamber such that a first pressure in the first chamber is less than a second pressure in the second chamber.

6. The glass manufacturing apparatus of claim 5, further comprising a third enclosure wall attached to the first enclosure wall and the second enclosure wall.

7. The glass manufacturing apparatus of claim 6, wherein the third enclosure wall extends perpendicular to the first enclosure wall and the second enclosure wall.

8. The glass manufacturing apparatus of claim 5, wherein the third enclosure wall comprises a second opening in fluid communication with the gas supply apparatus such that the gas supply apparatus is configured to deliver gas through the second opening to the second chamber.

9. The glass manufacturing apparatus of claim 5, further comprising a heating element positioned within the second chamber.

10. The glass manufacturing apparatus of claim 5, wherein a vertical plane bisects the glass ribbon forming device, and an axis perpendicular to the vertical plane intersects the glass ribbon forming device and the second chamber.

11. The glass manufacturing apparatus of claim 10, wherein a second axis parallel to the vertical plane intersects the glass ribbon forming device and the second chamber.

12. The glass manufacturing apparatus of claim 5, further comprising a ceramic tube extending through the opening and in fluid communication with the gas supply apparatus.

13. A method of manufacturing a ribbon comprising:
directing a glass ribbon from a glass ribbon forming device along a travel path in a travel direction, the glass ribbon forming device positioned in a first chamber; and
delivering gas to a second chamber to increase a second pressure in the second chamber such that the second pressure is greater than a first pressure in the first chamber, wherein the first chamber is enclosed within the second chamber comprising an enclosure surrounding the first chamber.

14. The method of claim 13, wherein the gas is delivered to the second chamber through a plurality of openings in the enclosure.

15. The method of claim 13, further comprising heating the first chamber with a heating element positioned within the second chamber.

16. The method of claim 15, wherein the delivering the gas comprises directing the gas away from the heating element.

17. The method of claim 13, further comprising positioning the enclosure such that a vertical plane bisects the glass ribbon forming device, and an axis perpendicular to the vertical plane intersects the glass ribbon forming device and the second chamber.

18. The method of claim 17, wherein a second axis parallel to the vertical plane intersects the glass ribbon forming device and the second chamber.
